(19) United States
(12) Patent Application Publication
(10) Pub. No.: US 2023/0141699 A1
(43) Pub. Date: May 11, 2023

(54) IMMERSIVE LEARNING FRAMEWORK FOR CENTRALIZED COMMUNICATIONS GATEWAY BETWEEN OPERATING SYSTEMS

(71) Applicant: IntelliMedia Networks, Inc., Leesburg, VA (US)

(72) Inventors: Darshan Sedani, Cerritos, CA (US); Teodros Gessesse, Leesburg, VA (US); Devang Ajmera, Gujarat (IN); Joy Shah, Gujarat (IN); Rajkumar Ramakrishnan, Gujarat (IN)

(73) Assignee: IntelliMedia Networks, Inc., Leesburg, VA (US)

(21) Appl. No.: 17/592,371

(22) Filed: Feb. 3, 2022

Related U.S. Application Data
(63) Continuation of application No. 17/592,296, filed on Feb. 3, 2022.
Application No. 17/592,296 is a continuation of application No. 17/523,504, filed on Nov. 10, 2021.

(51) Int. Cl. G09B 5/06

(52) U.S. Cl. CPC G09B 5/065

(57) ABSTRACT

A Immersive Learning Framework for Centralized Communications Gateway (ILFCCG) communication system comprises a centralized platform to be used by at least two different virtual devices and at least one distributed media gateway connected to a centralized platform via a backbone network, responsible for routing calls concerning communication terminals connected to its communication network and managed by the centralized platform and for controlling a user plane layer of the environment of the system.

### CROSS-REFERENCE TO RELATED APPLICATIONS

This application is related to and claims priority to U.S. Application entitled “Learning Training Management System; Patent Application”, Ser. No. 17/523,504, filed Nov. 10, 2021 and U.S. Application entitled “Immersive Learning Application”, Ser. No. 17/592,296, filed Feb. 3, 2022, the entire disclosures of which is herein incorporated by reference as a part of this application.

### FIELD

This invention is in the field of the interaction among and between educational software systems, learning systems, courseware management, informational communications and visualization systems, and virtual reality presentation system software, students, teachers, and learning system administrators.

### DESCRIPTION OF RELATED ART

As the Internet has grown in speed and computing power, and with the rise of cloud-based data storage and software as a service, online education has become increasingly enabled. Many efforts at standardizing online education and providing tools to enable multiple kinds of course materials to be mixed together have arisen. A critical threshold has also been reached where networking bandwidth and data transfer speeds of massive amounts of data are now sufficient to allow blending of live data streams with live data pulled from user generated sources as well as data repositories. These factors have served to open a wide range of opportunities for designing and serving so-called massive open online courses to students worldwide.

Another convergence of technology is also maturing: the widespread availability of multiple kinds of user devices such as laptop computers, mobile phones, mobile tablets of various kinds, next-generation television program management services (so-called over-the-top (“OTT”) services), and virtual reality devices and related services. These devices are becoming sufficiently commonplace that widespread familiarity with their use is an enabler for convergent inter-operation of such device to enhance information delivery and interactivity. Users of such devices now often possess sufficient skills to be able to operate multiple devices and coordinate information between them with ease.

Taken together, these factors provide opportunities for development of inter-operating education systems which take advantage of multiple information delivery modalities including plain text, interactive text, audio, video, augmented reality and virtual reality data, collaborative workspaces, and various combinations of live interactions between students and teachers while sharing and even contributing to information flows displayed on multiple devices simultaneously.

Such new systems serve to enhance learning rates of student, collaboration rates among professionals, increase retention of subject matter and may even serve to enhance the rate of new discoveries in science by scientific research communities.

The Immersive Learning Framework for Centralized Communications Gateway disclosed hereunder is a component of one such integrative software system in this new genre.

### SUMMARY

A method and system of creating a framework from centralized communications between a central server and one or a plurality of remote operating systems. According to an embodiment, the method includes, by at least one computer, providing a framework structure with a plurality of callable communications interfaces as a gateway supporting communication between and among a centralized server operating system and one or a plurality of devices operating a tvOS operating system, providing a framework with a plurality of callable communications interfaces supporting communication between and among the centralized server operating system and one or a plurality of devices operating a Roku OS operating system, and providing a framework with a plurality of callable communications interfaces supporting communication between and among the centralized server operating system and one or a plurality of devices operating a iOS mobile operating system.

The method, according to an embodiment, includes providing a framework with a plurality of callable communications interfaces supporting communication between and among the centralized server operating system and one or a plurality of devices operating an Android mobile operating system, providing a framework with a plurality of callable communications interfaces supporting communication between and among the centralized server operating system and any combination of one or the plurality of devices operating a tvOS or Roku OS or iOS or Android mobile operating systems, and providing a set of callable protocols handling each type of file or data stream communicated, respectively using a file type or a data stream native protocols.

Additional aspects will be set forth in part in the description which follows and, in part, will be apparent from the description, or may be learned by practice of the presented embodiments of the disclosure.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating software components and their data flow relationships to each other according to an embodiment.

FIG. 2 is a notional diagram illustrating user hardware components of the system and their interaction through the centralized communications software according to an embodiment.

### DETAILED DESCRIPTION

Herein below, various embodiments of the disclosure are described with reference to drawings. Reference is made in detail to embodiments, examples of which are illustrated in the accompanying drawings. In this regard, the embodiments may have different forms and should not be construed as being limited to the descriptions set forth herein. In order to further clearly describe features of the embodiments, descriptions of other features that are well known to one of ordinary skill in the art are omitted here.

Immersive Learning Framework for Centralized Communications Gateway (ILFCCG) is a component system of Immersive Learning Application (ILA), which in turn is a cloud-based integrated software system providing a rich context for education of trainees, employees in enterprise organizations, students in institutional settings, as well as individual students, through the operation of courseware, testing, skills validation and certification, courseware management, and inter-personal interactions of students and teachers in various ways. One core concept is providing a learning environment which is immersive in the sense that the student can utilize every available communications and display technology to be fully immersed in a simulated or artificial environment. The student is able to tune this environment to his/her own optimum style of information absorption.

ILFCCG is a communication system comprises a centralized platform that can be used by at least two different virtual devices and that comprises at least equipment and services management means, subscriber/subscription data management means and a call server responsible for jointly managing the control plane layer, and it at least one distributed media gateway connected to the centralized platform via a backbone network and responsible for the interconnection between the centralized platform and a routing center of a communication network of an associated network operator, responsible for routing calls concerning communication terminals connected to its communication network and managed by the centralized platform and for controlling a user plane layer of the environment of the system.

ILFCCG can carry video, audio, text, and images, with each type of file or data stream utilizing its own native protocols.

The ILFCCG operates as a centralized platform configured to be used by at least two mobile virtual operators and comprising equipment and services management devices, subscriber/subscription data management devices and a call server, arranged to manage jointly a user control plane layer, wherein each mobile virtual network operator (MVNO) provides subscription-based service for subscribers, and distributed media gateways connected to said centralized platform via a backbone network, each of the at least two mobile virtual operators includes a routing center and one or more of the distributed media gateways that are associated with the mobile virtual operators, wherein each of the distributed media gateways interconnects the centralized platform to the routing center of a communication network for the MVNO, said each routing center being managed by the centralized platform and configured to route calls from communication terminals to the communication network, and each of the distributed media gateways further being configured to control the user control plane layer jointly with the centralized platform.

According to an embodiment, users are able to operate multiple devices and coordinate information between them. This coordination of information is known as “second screening”. A recent study by Global Web Index found that over 50% of global consumers practice a behavior known as “second screening,” defining the act of using another device while watching TV. Currently, the majority of second screening activity is unrelated to the content watched on TV, including chatting, social media usage, and viewing email. According to an embodiment, this invention redefines “second screening” by providing additional and relevant content accompanying the content watched on TV utilizing a common framework to gather and use existing and live data and presenting the data in a variety of presentation devices. Applications such as news and sports polling, education, and related skills assessment tests, and accessing expanded information related to the main TV content become integrated with the primary content.

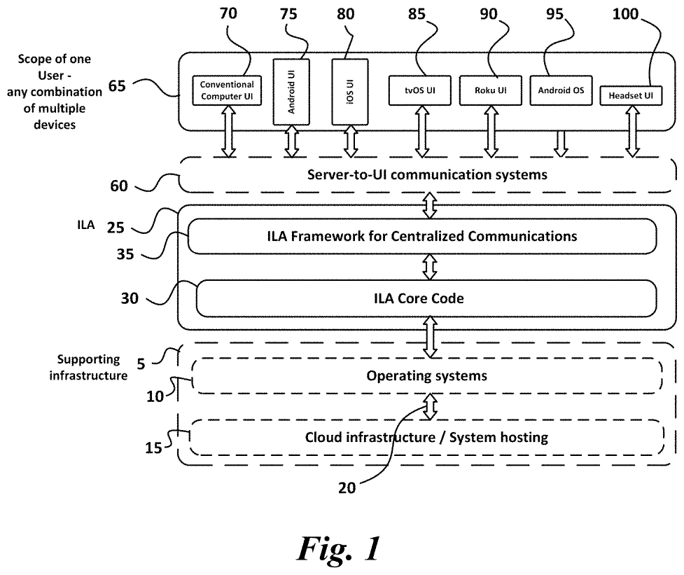

FIG. 1 illustrates software components and their data flow relationships to each other according to an embodiment. Referring to FIG. 1, ILFCCG is supported in a context of other software which are not parts of which ILA is comprised but are necessary for ILA operating correctly. These components are illustrated in dashed outlines. A Supporting infrastructure 5 is comprised of a so-called cloud hosting environment of servers (cloud infrastructure/system hosting) 15, operating systems 10, and Internet components in communication with each other according to data flows 20, indicated generically by double arrows throughout FIG. 1. Communications between said servers and remote user devices may be through generic Internet server-to-user-interface communication systems 60.

According to an embodiment, a software architecture of ILA 25 comprises a body of core code 30, together with distinct modules providing specific services. The core code 30 in turn operates a framework for centralized communications, Immersive Learning Application (ILA) Framework for Centralized Communications (ILFCCG 35.

According to an embodiment, the Framework for Centralized Communications 35 is communicating through said server-to-user-interface communication systems 60, to one or any combination of an array of user devices within the scope 65 comprising a conventional computer display (computer UI) 70, an Android user interface display 75, an iOS user interface display 80, a tvOS user interface display 85, a Roku user interface display 90, an Android OS user interface display 95, and a virtual reality headset user interface display 100. Each type of file or data stream is handled using protocols native to the specific file type or type of data stream.

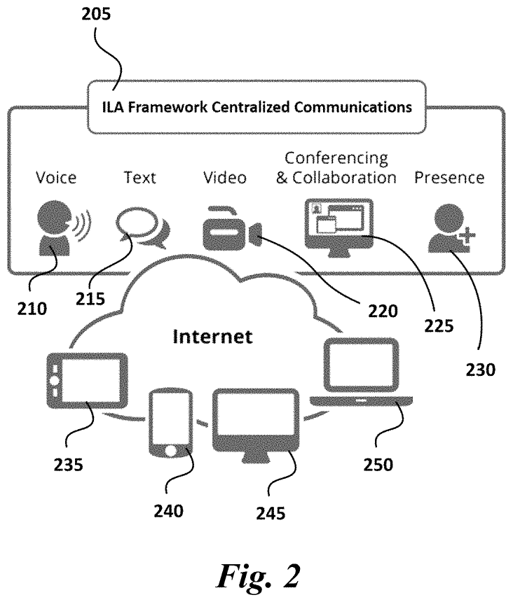

FIG. 2 illustrates user hardware components of the system and interaction thereof through the centralized communications software according to an embodiment. FIG. 2 illustrates the ILA Communication Service diagram of Immersive Learning Application (ILA) Framework for Centralized Communication (ILFCCG) according to an embodiment, describing the platform communicating with different parts of the system. The ILA Framework Centralized Communications (ILA Communication Service) 205 supports communications with other platforms in a centralized manner. In the embodiment illustrated, communication services include voice 210, text 215, video 220, conferencing or collaborating 225, or presence 230, which with all elements are accessed over the cloud by the users. The user using any of various platforms, such as mobile 240, ipad/tablet 235, laptop/desktop 245 or a Tv OS 250 communicates through the centralized data server where the data is shared per the request received from corresponding platform.

The ILA Framework Centralized Communications (ILA Communication Service) 205 supports interaction between various operating systems of different devices. Using FIG. 2, as an example, a user using a device with Tv OS 250 may collaborate with another user using a mobile 240 device where the mobile 240 device generally operates according to a specific operating system that is different from the Tv OS 250. The ILA Framework Centralized Communications (ILA Communication Service) 205 thus allows users to be presented with guided, controlled or customized content using any device with one or more of the users referring or directing any of the other users to a particular content being presented. According to an embodiment, users are presented with guided view of a particular content such as voice 210, text 215, video 220, etc., or a portion of the content being presented where the users may use different devices that operate according to specific operating systems or hardware for example, tvOS, RokuOS, iOS, AndroidOS, etc.

The system and method of the centralized communication in FIG. 2 enables delivery of formatted/customized information among users using various devices such as Tv OS 250, mobile 240, etc. Relevant content accompanying the information may be presented utilizing a common framework to gather and use existing and live data.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method of creating a framework from centralized communications between a central server and one or a plurality of remote operating systems, comprising:
by at least one computer:
providing a framework structure with a plurality of callable communications interfaces as a gateway supporting communication between and among a centralized server operating system and one or a plurality of devices operating a tvOS operating system,
providing a framework with a plurality of callable communications interfaces supporting communication between and among the centralized server operating system and one or a plurality of devices operating a Roku OS operating system,
providing a framework with a plurality of callable communications interfaces supporting communication between and among the centralized server operating system and one or a plurality of devices operating a iOS mobile operating system,
providing a framework with a plurality of callable communications interfaces supporting communication between and among the centralized server operating system and one or a plurality of devices operating an Android mobile operating system,
providing a framework with a plurality of callable communications interfaces supporting communication between and among the centralized server operating system and any combination of one or the plurality of devices operating a tvOS or Roku OS or iOS or Android mobile operating systems, and
providing a set of callable protocols handling each type of file or data stream communicated, respectively using a file type or a data stream native protocols.
